(19) United States
(12) Patent Application Publication
(10) Pub. No.: US 2006/0246338 A1
(43) Pub. Date: Nov. 2, 2006

(54) Refilling device for electronic unit with a fuel cell

(76) Inventors: Sjur Haugen, Lommedalen (NO); Blair Heffelfinger, Port Coquitlan (CA)

Correspondence Address: Jeffrey Pearce, 34825 Sultan-Startup Rd, Sultan, WA, 98294, US

(21) Appl. No.: 10/566,348

(22) PCT Filed: Jul. 28, 2004
(86) PCT No.: PCT/NO04/00230

§ 371 Date: Jun. 9, 2006

(30) Foreign Application Priority Data
Jul. 29, 2003 (NO) 20033382

(51) Int. Cl. H01M 8/04; B65D 25/04

(52) U.S. Cl. 429/35; 220/530

(57) ABSTRACT

Cartridge for refilling methanol or methanol/water as fuel to an electronic unit with a fuel cell. The cartridge includes a connection device comprising: an axially slidable cylinder (4) with an upper end that with a first sealing means (3) is brought sealingly through an inner cartridge wall (2) that constitutes the container for the fuel; passage way for fuel arranged along the cylinder, with opening (5) for fuel in at least two different distances from the upper end of the cylinder, of which both openings are located outside the inner cartridge wall with the cylinder in an outer position; a second sealing means (6) arranged at a lower end of the cylinder, sealing against an opening through an outer cartridge wall; a spring (8) arranged around the cylinder such that the first sealing means is pressed sealingly against the inner cartridge wall, and the second sealing means is pressed sealingly against the outer cartridge wall, such that the passage way for fuel is kept closed. The spring can be compressed at the same time as the cylinder is displaced axially to an inner position, such that the passage way for fuel is opened from the container for fuel to outside the connection device.

### FIELD OF THE INVENTION

The present invention regards a cartridge for refilling of methanol or methanol/water as fuel to an electronic unit with a fuel cell that is using the fuel for production of electric power for operation of the electronic unit. The cartridge is leakage proof, tamper proof and child proof. The invention also regards said electronic unit and a fuel container for an electronic unit. The cartridge, the electronic unit and the fuel container are equipped with a connection device that makes the units leakage proof, non-tempering and child proof with respect to the fuel.

### BACKGROUND OF THE INVENTION AND PRIOR ART

Fuel cells are at present an alternative for delivery of electric power to electronic units and other means that require electric power for operation. A number of fuel cells exist, for example “Polymer Exchange Membrane” (PEM) fuel cells based on hydrogen as fuel, and “Direct Methanol Fuel Cells” (DMFC) based on methanol as fuel.

Methanol is a preferable fuel for fuel cells due to its high concentration of hydrogen, it can be reformed at low temperatures, it is liquid at ambient conditions, it is easily biological degradable and it can be produced from fossil materials and biomaterials. Even though methanol has many preferable properties it is both flammable and toxic for humans and other organisms. If methanol is to be commonly used as fuel in the consumer market, the utilization has to entail sufficient safety against unwanted exposure and leakage of the fuel.

A demand exists for devices that for the above-mentioned objectives results in improved safety against unwanted exposure and leakage of fuel.

### SUMMARY OF THE INVENTION

The above-mentioned demand is met with the present invention in that a cartridge is provided for refilling of methanol or methanol/water as fuel to an electronic unit with a fuel cell, which cartridge is constructed and distinguished as apparent from claim 1. An electronic unit is also provided, with construction and distinguishing features as apparent from claim 5. Further, a fuel container is provided, with construction and distinguishing features as apparent from claim 10.

With the cartridge, the electronic unit and the fuel container according to the present invention, beneficial properties are achieved by using a novel and distinguished connection device for connecting the cartridge to the fuel container of the electronic unit.

With the term a first sealing means it is considered any sealing means that can provide the aimed function, for example a plate, a sphere cap, a sphere segment, a sphere, a cone or another means that can be sealingly arranged against the inner cartridge wall. However, a plate is most preferred because of simplicity.

With the term a second sealing means it is considered any sealing means that can provide the aimed function, for example a cone, a sphere cap, a sphere segment, a sphere, a plate or another means that can be sealingly arranged against the outer cartridge wall. However, an oppositely oriented cone is most preferred because of the preferable properties with respect to protection against tampering, fuel drainage and aligning.

With the term cylinder it is considered any elongated body that can be moved an axial distance in through an opening in the inner cartridge wall, such that in an inner position the cylinder's passage way for fuel is open, while in an outer position the cylinder's passage way for fuel is closed. The passage way can be a boring outside on the cylinder, or the cylinder can be hollow in form of a pipe that is closed in its upper end and preferably also in its lower end, with openings in the pipe wall for fuel. The passage way in the cylinder is thereby considered as openings for fluid communication. A hollow cylinder is preferred because of simplicity for manufacture.

The connection device is preferably arranged within the cartridge, and encompassed by the outer cartridge wall, a distance from the opening, for increased safety against tampering. A similar construction applies for the fuel container. However, units that are to be connected are equipped with adapted dimensions such that the outer walls and outer pipes in the connection devices can be passed into each other, preferably by screwing. During storage or operation an adapted protective cap is screwed on to the connection device, such that three barriers exist against leakage.

### DRAWINGS

The invention is illustrated with drawings, of which:

FIG. 1 illustrates a section of the cartridge for filling of methanol or other fuel, which section illustrates the connection device in form of an outlet device according to the present invention.

FIG. 2 illustrates the cartridge illustrated on FIG. 1 and its outlet device, and a connection device in form of an inlet device to a fuel container for example into an electronic unit.

FIG. 3 illustrates the connection of the connecting devices according to the present invention.

### DETAILED DESCRIPTION

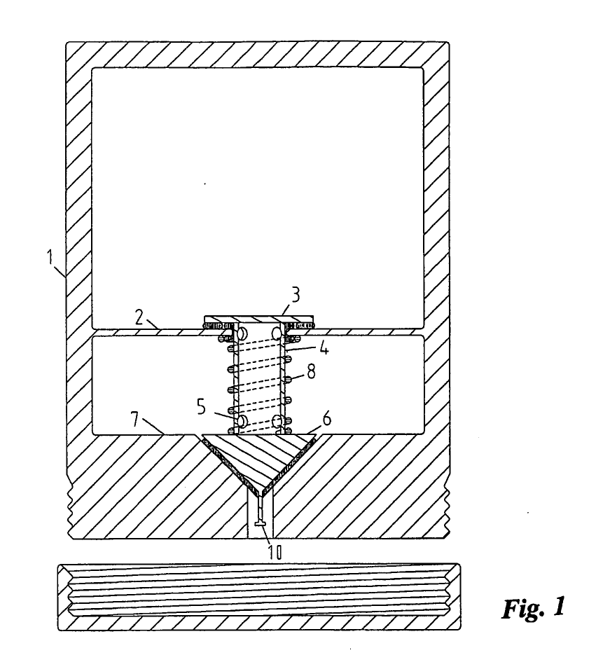

Reference is first made to FIG. 1, where a cartridge 1 according to the invention, containing methanol, is illustrated. More specific, an inner cartridge wall 2 is illustrated, through which a hole is arranged and a hollow cylinder 4 is brought through with a plate 3 on the upper end of the cylinder. Around the cylinder a spring 8 is arranged, and the hollow cylinder is equipped with at least two holes or set of holes 5 at different distance from the upper end of the cylinder. With the cylinder in an outer position the holes 5 are outside the inner cartridge wall. In the lower end of the cylinder an oppositely oriented cone 6 is arranged, sealingly pressed against an oppositely oriented cone form constituting a part of an outer cartridge wall 7. In the apex of the cone form 7 a hole is provided, and below said hole a pipe or a flow way is arranged such that the hole lays within the end of the pipe or the flow way. A push bar 10 is arranged downwards from the apex of the cone. The spring 8 is pressing such that the plate 3 is sealingly pressed against the inner cartridge wall 2. Likewise the spring is pressing the cone 6 sealingly against the cone form 7. On the sealing surfaces sealing material is preferably arranged, such as fuel compatible elastomeric material, which is illustrated on the figures in form of the most densely hatched material.

Thus the fuel in the cartridge 1 is enclosed by two sealing barriers, namely between the plate 3 and the inner cartridge wall 2 and between the cone 6 and the cone form 7 that constitutes a part of the outer cartridge wall. However, the hollow cylinder 4 is axially slidable. If a further push bar is brought up through the pipe from below towards the apex of the cone 6, it will hit the push bar 10 and push it, the cone, the cylinder and the plate axially towards the center of the cartridge. If the displacement is sufficient the upper set of holes or the upper hole in the hollow cylinder 4 will be displaced such that said holes become openings through which fuel can flow into the hollow cylinder 4 from the interior of the cartridge. From the inner of the hollow cylinder the fuel can flow out through the lower of the two set of holes through the wall in the hollow cylinder, and further along the space formed by having the cone 6 displaced up from the cone form 7, and out the opening through the apex of the cone form and further out through the pipe arranged below.

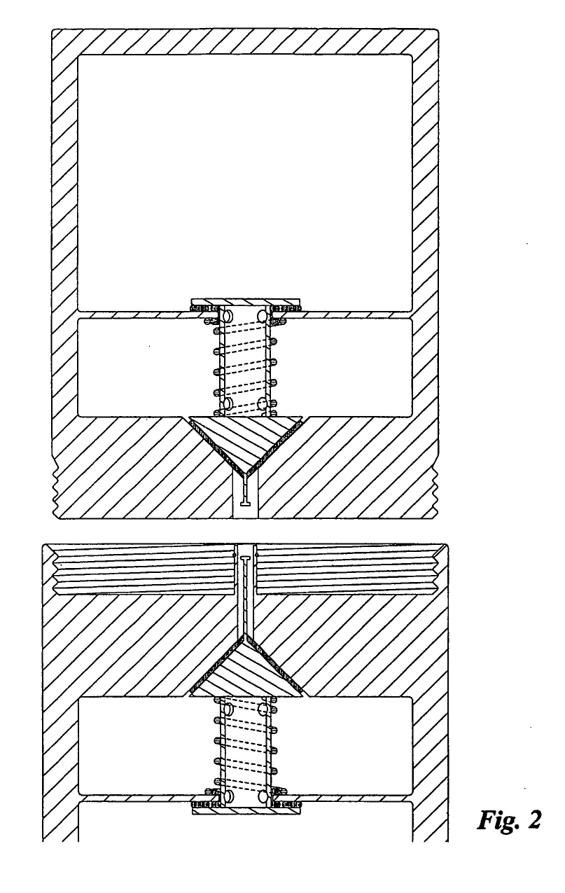

Reference is now made to FIG. 2, which illustrates the cartridge, the outlet device and a corresponding inlet device on the unit where the cartridge is to be connected. The unit is an electronic unit with a fuel tank for storage of fuel for utilization in a fuel cell for production of electric power for operation of the electronic unit. The outlet device and the inlet device are in principle identical, but as mentioned above and as illustrated on the figure an additional push bar is required. The push bar or the push bars can be arranged on either the outlet device, the inlet device or both, in that the combined length of push bar is adapted such that the flow through each unit becomes as described above. More specific it is meant that when the connections are mated, for example by screwing, the displacement of the hollow cylinders with holes, sealing surfaces and cones, is such that the one set of holes on each cylinder comes into the respective fuel container, while the other set of holes are outside, such that fluid can communicate from one tank to the next, i.e. from the cartridge to a fuel tank in the electronic unit.

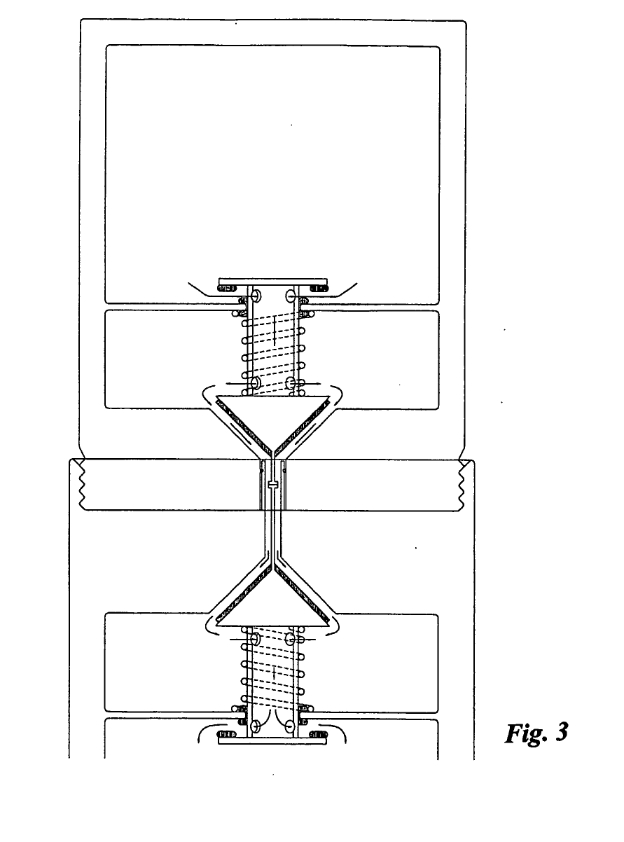

Connection and flow of fuel is further illustrated on FIG. 3. Methanol flows from the cartridge to the fuel tank while air flows the opposite way. The methanol flow is illustrated with arrows. The cartridge is fastened to the fuel tank such that fuel does not leak outside the connection. In principle all connection devices are identical, except from the push bar and the outer walls and pipes/flow ways that are to be mated, as described above.

In a preferable embodiment a push bar is arranged from the lower end of the cylinder, through openings in the outer cartridge wall and a distance into a pipe below, in that the length of the push bar is adapted such that by mating the connection a correspondingly constructed push bar on the connection device of the connected unit will together with the first mentioned push bar provide a sufficient displacement in the connection devices so that fuel can be passed from the cartridge to a fuel container connected to the connection device of the second unit. So is a standardized embodiment of the push bars achieved.

The cartridge and the fuel container is preferably equipped with a protective cap on the connection devices. The connection devices per se are preferably built into a protective cap that for example can include threads for connection, for example male threads on one connection and female threads on the corresponding connection. All containers, which means the cartridge and the fuel containers in the electronic unit, are preferably equipped with double walls and are manufactured by non-sparking, recyclable materials, such as stainless steel.

The electronic unit is chosen amongst a mobile telephone, a computer, a calculation unit, a camera, a recording unit and any other electric power operated electronic unit.

The fuel containers are either integrated into the electronic unit, such that refilling is from the cartridge according to the invention, or it is put into the electronic unit.

1-13. (canceled)

14. A cartridge for holding a fuel comprising:
an enclosing outer wall;
an inner wall that separates an interior of the cartridge into a first chamber and a second chamber;
an inner opening in the inner wall;
a recess in a surface of the outer wall in the second chamber;
a outer channel extending through the outer wall and connecting the second chamber, via the recess, to an external region outside of the outer wall;
an axially movable sealing member that extends through the inner opening;
a first sealing arrangement provided on a first end the axially movable sealing member within the first chamber;
a second sealing arrangement provided on a second end of the axially movable sealing member that is opposite the first end;
a inner channel that extends from a first opening in the axially movable sealing member, through an interior channel in the axially movable sealing member, and to a second opening in the axially movable sealing member;
in which:
when the axially movable sealing member is in a closed position, the first sealing arrangement seats against the inner wall, blocking communication of the first opening with the first chamber; the second sealing arrangement seats against the outer wall, in the recess, blocking communication of second chamber with the external region, whereby the flow channel is closed to flow of the fuel between the first chamber and the external region;
when the axially movable sealing member is in an open position, the first opening in the axially movable sealing member is in fluid communication with the first chamber, the second opening in the axially movable sealing member is in fluid communication with the second chamber, and the second chamber is in fluid communication, through the recess and the outer channel, with the external region, whereby fuel can flow between the first chamber and the external region via the inner channel, the second chamber, the recess, and the outer channel;
further comprising a biasing element biasing the axially movable sealing member into the closed position.

15. A cartridge as in claim 14, further comprising a pushing element connected to the second sealing arrangement and extending into the outer channel such that the axially movable sealing member is moved from the closed to the open position when an axial force is applied to the pushing element sufficient to overcome a biasing force of the biasing element.

16. A cartridge as in claim 14, in which the axially movable sealing member is a hollow cylinder and the first and second openings are holes through the cylinder.

17. A cartridge as in claim 14, in which the first sealing arrangement comprises an at least substantially annular flange-like plate that extends around the inner opening.

18. A cartridge as in claim 17, further comprising a fuel-resistant, elastomeric sealing material provided on the flange-like plate, extending around the inner opening between the flange-like plate and the inner wall, and providing a fuel-tight seal when the axially movable sealing member is in the closed position.

19. A cartridge as in claim 14, in which:
the recess is substantially conical; and
the second sealing arrangement comprises an at least substantially conical plug that seats in the recess when the axially movable sealing member is in the closed position.

20. A cartridge as in claim 19, further comprising a fuel-resistant, elastomeric sealing material provided on the conical plug and providing a fuel-tight seal between the conical plug and the recess when the axially movable sealing member is in the closed position.

21. A cartridge as in claim 14, in which:
the fuel is contained in the upper chamber; and
when the axially movable sealing member is in the open position, a fuel flow direction is from the upper chamber to and out through the outer channel.

22. A cartridge as in claim 14, in which:
the upper chamber is provided for receiving and holding fuel-cell fuel for generating electricity for running an electronic device.

23. A cartridge as in claim 14, in which the fuel comprises methanol.

24. A pair of fuel cartridges—a supply cartridge and a receiving cartridge—each provided according to claim 15, in which:
A) the fuel is initially contained in the upper chamber;
B) the receiving cartridge further comprises a tubular member that extends axially outward from the receiving cartridge's outer channel and is dimensioned to sealingly mate with the supply cartridge's outer channel;
C) the receiving cartridge's pushing element extends partially within the tubular member;
D) the supply cartridge and receiving cartridge are provided with mating fittings such that:
i) when the supply cartridge and receiving cartridge are connected, the receiving cartridge's tubular member is aligned with and extends into the supply cartridge's outer channel and the receiving cartridge's pushing element contacts and applies the axial force to the supply cartridge's pushing element and the supply cartridge's pushing element applies a counteracting axial force to the receiving cartridge's pushing element, whereby:
a) both the supply cartridge's axially movable sealing member and the receiving cartridge's axially movable sealing member assume the open position;
b) the supply cartridge's first chamber is in fluid communication with the receiving cartridge's first chamber such that the fuel flows from the supply cartridge's first chamber to the receiving cartridge's first chamber;
ii) when the supply cartridge and receiving cartridge are disconnected, the receiving cartridge's pushing element and the supply cartridge's pushing element no longer contact one another and the receiving cartridge's and supply cartridge's respective biasing elements bias the respecting sealing arrangements into the closed position.

25. A cartridge as in claim 24, in which:
the receiving cartridge is provided for receiving and holding fuel-cell fuel for generating electricity for running an electronic device.

26. A cartridge as in claim 24, in which the fuel comprises methanol.

27. An electronic device that comprises:
a fuel cell for generating electricity from the fuel; and
a fuel-holding cartridge configured according to claim 14.

28. An electronic device as in claim 27 selected from the group consisting of a mobile telephone, a computer, a calculation unit, a camera, and a recording unit.

29. A cartridge for holding a fuel comprising:
an enclosing outer wall;
an inner wall that separates an interior of the cartridge into a first chamber, which contains the fuel, and a second chamber;
an inner opening in the inner wall;
a substantially conical recess in a surface of the outer wall in the second chamber;
a outer channel extending through the outer wall and connecting the second chamber, via the recess, to an external region outside of the outer wall;
an axially movable sealing member that extends through the inner opening;
a first sealing arrangement provided on a first end the axially movable sealing member within the first chamber;
a second sealing arrangement provided on a second end of the axially movable sealing member that is opposite the first end;
a inner channel that extends from a first opening in the axially movable sealing member, through an interior channel in the axially movable sealing member, and to a second opening in the axially movable sealing member;
in which:
the axially movable sealing member is a hollow cylinder and the first and second openings are holes through the cylinder;
when the axially movable sealing member is in a closed position, the first sealing arrangement seats against the inner wall, blocking communication of the first opening with the first chamber; the second sealing arrangement seats against the outer wall, in the recess, blocking communication of second chamber with the external region, whereby the flow channel is closed to flow of the fuel between the first chamber and the external region;
when the axially movable sealing member is in an open position, the first opening in the axially movable sealing member is in fluid communication with the first chamber, the second opening in the axially movable sealing member is in fluid communication with the second chamber, and the second chamber is in fluid communication, through the recess and the outer channel, with the external region, whereby fuel can flow between the first chamber and the external region via the inner channel, the second chamber, the recess, and the outer channel;
the first sealing arrangement comprises an at least substantially annular flange-like plate that extends around the inner opening;
a fuel-resistant, elastomeric sealing material is provided on the flange-like plate, extending around the inner opening between the flange-like plate and the inner wall, and providing a fuel-tight seal when the axially movable sealing member is in the closed position;
the second sealing arrangement comprises an at least substantially conical plug that seats in the recess when the axially movable sealing member is in the closed position
further comprising:
a biasing element biasing the axially movable sealing member into the closed position;
a pushing element connected to the second sealing arrangement and extending into the outer channel such that the axially movable sealing member is moved from the closed to the open position when an axial force is applied to the pushing element sufficient to overcome a biasing force of the biasing element.
